(19) United States
(12) Patent Application Publication
(10) Pub. No.: US 2025/0150834 A1
(43) Pub. Date: May 8, 2025

(54) SYSTEMS AND METHODS FOR USER EQUIPMENT LOCATION VERIFICATION

(71) Applicant: ZTE CORPORATION, Shenzhen (CN)

(72) Inventors: Fangyu CUI, Shenzhen (CN); Nan ZHANG, Shenzhen (CN); Jianwu DOU, Shenzhen (CN); Wei CAO, Shenzhen (CN)

(73) Assignee: ZTE CORPORATION, Shenzhen (CN)

(21) Appl. No.: 19/015,323

(22) Filed: Jan. 9, 2025

Related U.S. Application Data
(63) Continuation of application No. PCT/CN2022/111560, filed on Aug. 10, 2022.

(51) Int. Cl. H04W 12/63; H04L 5/00; H04W 12/60; H04W 76/30

(52) U.S. Cl. CPC H04W 12/63; H04L 5/0051; H04W 12/66; H04W 76/30

(57) ABSTRACT

Presented are systems and methods for user equipment location verification. A first network node may perform location verification of a wireless communication device. Whether to release a connection with the wireless communication device can be determined by a second network node.

### CROSS-REFERENCE TO RELATED APPLICATION

This application claims the benefit of priority under 35 U.S.C. § 120 as a continuation of PCT Patent Application No. PCT/CN2022/111560, filed on Aug. 10, 2022, the disclosure of which is incorporated herein by reference in its entirety.

### TECHNICAL FIELD

The disclosure relates generally to wireless communications, including but not limited to systems and methods for user equipment location verification.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments (e.g., including combining features from various disclosed examples, embodiments and/or implementations) can be made while remaining within the scope of this disclosure.

At least one aspect is directed to a system, method, apparatus, or a computer-readable medium of the following. A first network node (e.g., a core network (CN), a radio access network (RAN), and/or a base station (BS)) may perform location verification of a wireless communication device (e.g., a user equipment (UE)). Whether to release a connection with the wireless communication device can be determined by a second network node.

In some embodiments, the first network node may comprise at least one node of a core network (CN). The second network node may comprise a wireless communication node of a radio access network (RAN). In some embodiments, the second network node may comprise the at least one node of the CN. In some embodiments, the at least one node of the CN may comprise at least one of a function entity. The first network node may comprise the wireless communication node of the RAN. In some embodiments, the first network node and the second network node may comprise the at least one node of the CN. In some embodiments, the first network node and the second network node may be/comprise the wireless communication node of the RAN. In some embodiments, the first network node and the second network node may be same. In some embodiments, the first network node and the second network node may comprise different function entities in the CN.

In some embodiments, the at least one node of the CN may perform the location verification. The at least one node of the CN may determine to release or not to release the connection with the wireless communication device according to the location verification. The at least one node of the CN may send an indication to release or not to release the connection with the wireless communication device to the wireless communication node. The at least one node of the CN may send information (e.g., a reason/justification of the decision) supporting the indication to release or not to release the connection to the wireless communication node. The wireless communication node can be configured to release or not to release the connection according to at least one of: the indication, or the supporting information. To release the connection may comprise at least one of: to release a radio resource control (RRC) connection with the wireless communication device, or to reject (e.g., disallow) access from the wireless communication device. In some embodiments, the information supporting the indication to release or not to release the connection comprises at least one of: a reason why the connection is released, a time period that a wireless device is not allowed to access, a notification that a wireless device has passed/failed a location verification, or a notification that normal transmission can be performed.

In some embodiments, the at least one node of the CN may perform the location verification. The at least one node of the CN may send an indication of reliability of the wireless communication device, according to the location verification to wireless communication node. The wireless communication node can be configured to at least one of: determine to release or not to release the connection with the wireless communication device, according to the indication of reliability; or send a decision of the wireless communication node to release or not to release the connection, to the at least one node of the CN.

In some embodiments, the at least one node of the CN may perform the location verification. The at least one node of the CN may determine to perform or not to perform the location verification another time (e.g., to repeat/re-perform the location verification), according to the location verification. The at least one node of the CN may send a first indication to perform or not to perform the location verification another time to the wireless communication node. The at least one node of the CN may send a second indication to release or not to release the connection with the wireless communication device, when a number of times the location verification is performed exceeds a threshold, to the wireless communication node.

In some embodiments, the wireless communication node may perform the location verification according to at least one of: a criteria of the location verification, assistance information measured by the wireless communication node, or assistance information received from the wireless communication device. The wireless communication node may determine to release or not to release the connection with the wireless communication device according to the location verification. The wireless communication node may send at least one of: a decision of the wireless communication node to release or not to release the connection, or information (e.g., a reason/justification of the decision) supporting to release or not to release the connection, to the at least one node of the CN. The wireless communication node may send a reliability of the wireless communication device to the at least one node of the CN. The wireless communication node may store the reliability of the wireless communication device. In some embodiments, the information supporting the indication to release or not to release the connection comprises at least one of: a reason why the connection is released, a time period that a wireless device is not allowed to access, a notification that a wireless device has passed/failed a location verification, or a notification that normal transmission can be performed.

In some embodiments, the wireless communication node may perform the location verification according to at least one of: a criteria of the location verification, assistance information measured by the wireless communication node, or assistance information received from the wireless communication device. The wireless communication node may determine to perform or not to perform the location verification another time according to the location verification. The wireless communication node may send at least one of: a decision of the wireless communication node to perform or not to perform the location verification another time, or information (e.g., a reason/justification of the decision) supporting to perform or not to perform the location verification another time, to the at least one node of the CN. The wireless communication node may send a reliability of the wireless communication device to the at least one node of the CN. The wireless communication node may store the reliability of the wireless communication device. The wireless communication node may determine to release or not to release the connection with the wireless communication device, when a number of times the location verification is performed exceeds a threshold. In some embodiments, the information supporting the indication to perform or not to perform the location verification another time comprises at least one of: a reason why to perform location verification another time, a reason why not to perform location verification another time, a notification that a wireless device has passed/failed a location verification, or a notification that normal transmission can be performed.

In some embodiments, the criteria of the location verification can be pre-configured at the wireless communication node, or can be received from the at least one node of the CN. The assistance information measured by the wireless communication node may comprise at least one of: a round trip time, an uplink reference signal time difference of arrival, an angle of arrival, or a reference signal received power. The assistance information received from the wireless communication device may comprise at least one of: a time gap between a receiving downlink reference signal and a transmitting uplink reference signal, a coherence level between different uplink reference signals, a tracking area (TA) value, a location of the wireless communication device, a trajectory of the wireless communication device, a mobility status (e.g., a speed value, a moving direction, a velocity vector, and/or a speed range index) of the wireless communication device, a time instance corresponding to any of above, or a capability or type of the wireless communication device.

In some embodiments, the criteria for the location verification may comprise at least one of: a target value range, a target value, a tolerable range of error, or a confidence level, for at least one of: the assistance information measured by the wireless communication node, or the assistance information received from the wireless communication device. The wireless communication node may assign a flag to the wireless communication device according to the reliability. The wireless communication node may receive the flag for the wireless communication device from the at least one node of the CN. The wireless communication node may receive at least one of: an international mobile equipment identity (IMEI), or an international mobile subscriber identity (IMSI), from the at least one node of the CN. The wireless communication node may associate the reliability or the flag with at least one of: the IMEI, the IMSI, a radio network temporary identity (RNTI), or a defined virtual identity (ID). The wireless communication node may set a valid time for the reliability or the flag.

In some embodiments, the at least one node of the CN may assign/associate a flag to the wireless communication device according to the reliability. The at least one node of the CN may receive the flag for the wireless communication device from the wireless communication node. The at least one node of the CN may associate the reliability or the flag with at least one of: an international mobile equipment identity (IMEI), an international mobile subscriber identity (IMSI), a radio network temporary identity (RNTI), or a defined virtual identity (ID). The at least one node of the CN may set a valid time (e.g., valid duration or time window) for the reliability or the flag.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example Non-Terrestrial Network (NTN), in accordance with some embodiments of the present disclosure;

FIG. 4 illustrates an example multi-cell round trip time (multi-RTT) method, in accordance with some embodiments of the present disclosure;

FIG. 5 illustrates an example procedure of estimating round trip time (RTT), in accordance with some embodiments of the present disclosure;

FIG. 6 illustrates an example of positioning by a single satellite/aerial vehicle, in accordance with some embodiments of the present disclosure;

FIG. 7 illustrates a flow diagram of an example method for user equipment location verification, in accordance with some embodiments of the present disclosure; and

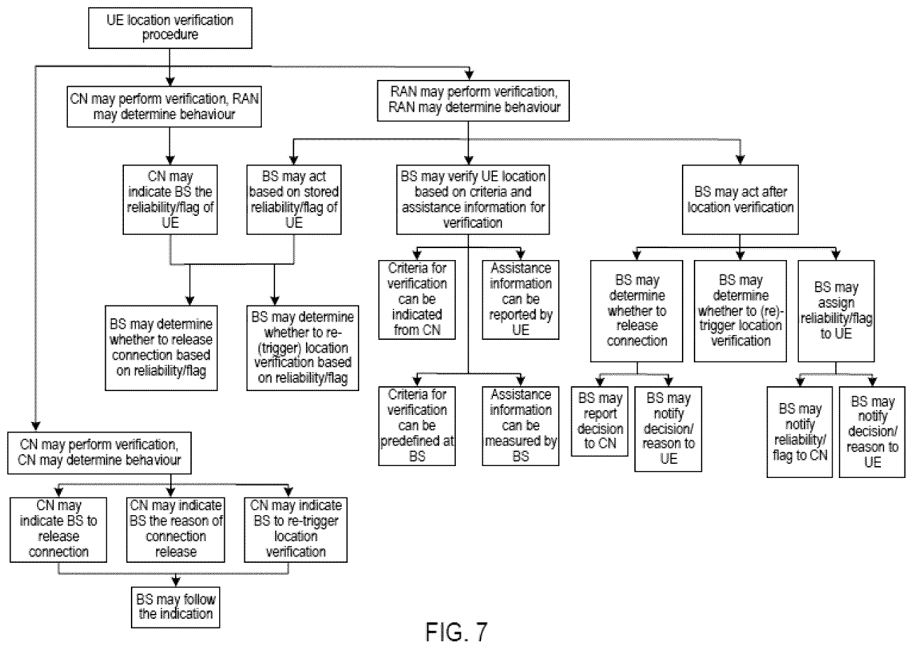

FIG. 8 illustrates a flow diagram for user equipment location verification, in accordance with an embodiment of the present disclosure.

### DETAILED DESCRIPTION

### 1. Mobile Communication Technology and Environment

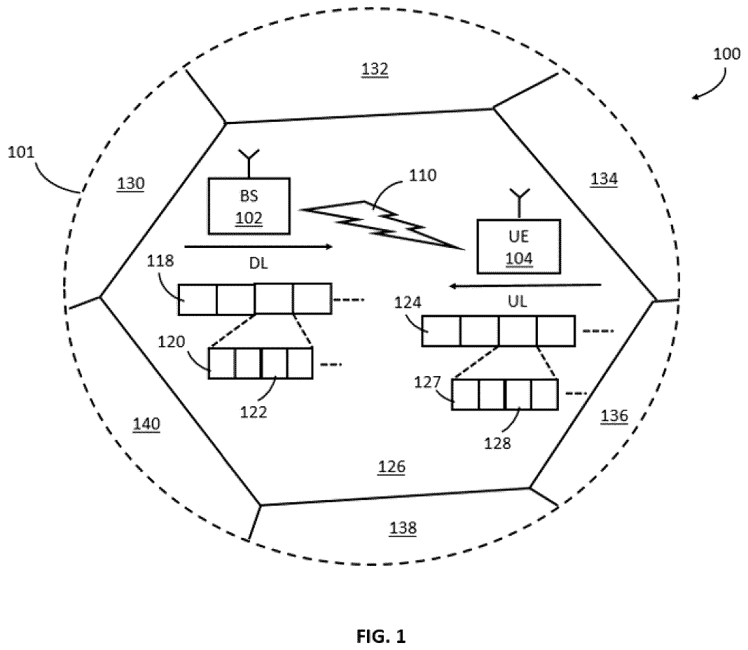

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

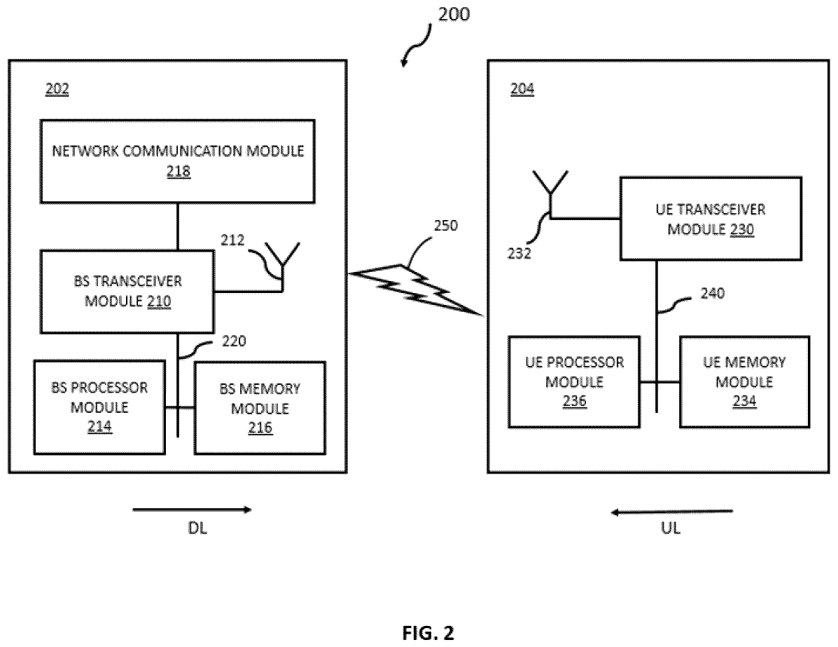

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for User Equipment (UE) Location Verification

Non-Terrestrial Network (NTN) user equipment (UE) can be implemented with Global Navigation Satellite System (GNSS) capability and can be configured to obtain/determine the UE's location. However, GNSS based positioning method is radio access technology (RAT) independent. A UE's position obtained by GNSS (e.g., reported to the network) may not be reliable/trustable by the network. Hence, interactions (e.g., who can be responsible for performing location verification, where justification criteria can be received from, and/or indications after verification) between a radio access network (RAN) and a core network (CN) regarding performing location verification on a user equipment (UE) is a problem that the present disclosure recognizes and provides solutions to address. The systems and methods presented herein include novel approaches for performing/implementing location verification of a UE.

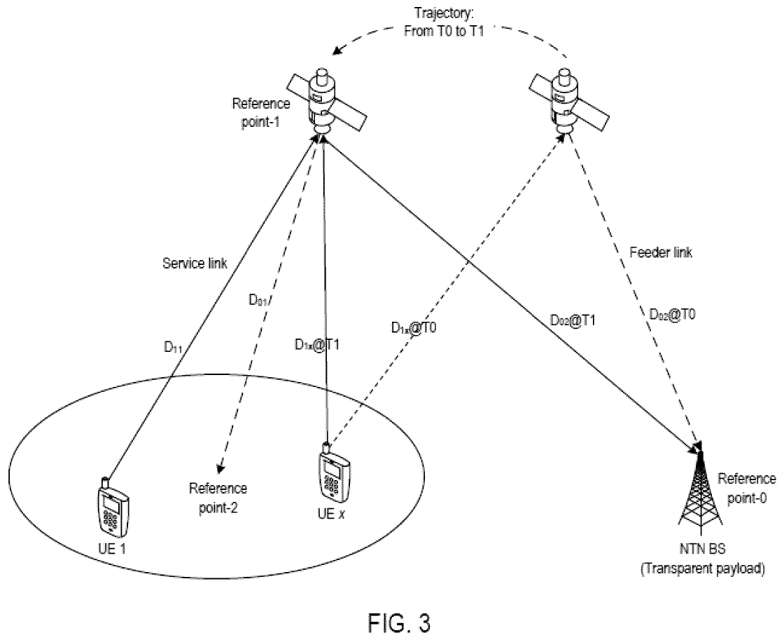

FIG. 3 illustrates an example representation of a NTN, e.g., a transparent NTN. In some embodiments, the link between a UE and a satellite may be a service link. The link between a base station (BS) and a satellite may be a feeder link. The feeder link can be common for all UEs within the same cell.

There may be several ways for verification. A network may perform a trustable positioning (e.g., network based positioning or RAT-dependent positioning) and may compare a result (of the trustable positioning) with a target location. The target location may be reported by a UE or determined by the network according to a CN which the UE is trying to access. If an error/different between these is within a tolerable range with a high enough probability, the UE's reported location can be thought/considered trustable. In some embodiments, a network may perform at least one measurement/estimation (e.g., reference signal receiving power (RSRP), round trip time (RTT), and/or timing advance (TA)) and may compare a result of the measurement/estimation with at least one target value based on a target location. If an error/different between these is within a tolerable range with a high enough probability, the UE's reported location can be thought/considered trustable.

Regarding the first approach, there can be multiple network based positioning methods in a terrestrial network (TN), which can be radio access technology dependent and can be thought trustable. The methods may include the UE communicating with multiple base stations simultaneously.

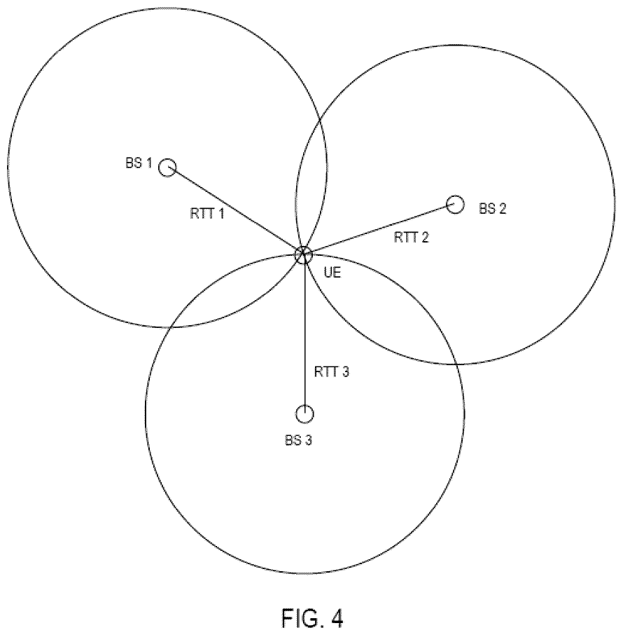

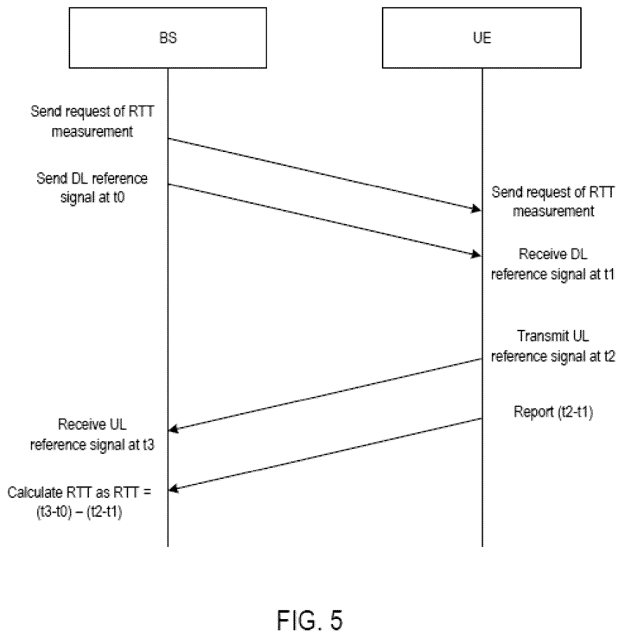

FIG. 4 illustrates an example multi-cell round trip time (multi-RTT) method. The network may estimate multiple RTTs between a UE and different BSs. The network may be able to know a distance between a UE and several reference points (e.g., BS locations), and can perform positioning through geometric calculation. In order to estimate the RTT, both downlink (DL) and uplink (UL) reference signals (RSs) may be configured. The network may first transmit the DL RS at time to. The UE may receive the DL RS at t₁, and may transmit UL RS at t₂. After transmitting the UL RS, the UE may report a time interval (t₂-t₁). The network may receive the UL RS at t₃ and may be able to obtain/determine the RTT as (t₃-t₀)-(t₂-t₁). Compared to a UL-time difference of arrival (TDOA) method, the BSs may not be required to be well synchronized since independent RTTs can be measured. The procedure of estimating RTT can be seen in FIG. 5.

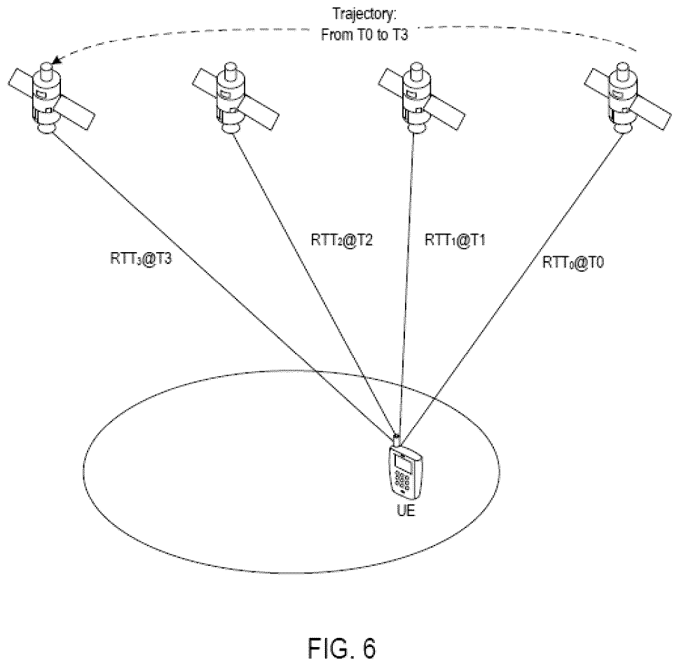

In NTN, there may not be enough satellites available for communication at a same time. FIG. 6 illustrates an example of positioning by using a single satellite/aerial vehicle. Multiple RTTs corresponding to a same BS/satellite/aerial vehicle at different time instants can be estimated in NTN. Furthermore, the RTT measurement may be replaced by a TA report or a UL RS measurement for positioning.

### Implementation Example 1: Procedure for UE Location Verification

In a system, information for UE location verification can be obtained in a radio access network (RAN). However, a location service (LCS) can be performed in a core network (CN) by at least one of access and mobility management function (AMF), location management function (LMF), enhanced serving mobile location center (E-SMLC), or secure user plane location (SUPL) location platform (SLP) modules. Hence, a location function may involve both the RAN and the CN. It may be possible to perform the (UE) location verification either in the RAN or in the CN, which may lead to different verification procedures and signalings. In the CN, the location verification may be performed at different function entities.

For performing a location verification, two key functions may be considered: (1) verify the location (e.g., compare UE reported location with the location obtained by RAT-dependent positioning); (2) determine the behavior (e.g., whether to release connection with UE, or re-trigger location verification) according to the verification result. Since these two functions may be separately deployed, the following examples of location verification may be possible.

Example 1: A CN may perform a location verification. The CN may determine whether to release a connection with a UE. The CN may send an indication to a BS regarding a decision on whether to release a connection with a UE. The BS may follow the CN's decision. The CN may also indicate a reason for the decision (e.g., the location verification is failed).

Example 2: A CN may perform a location verification. The CN may indicate a reliability of a UE to a BS. The BS may determine whether to release a connection with the UE according to the indicated reliability. The BS may report a decision on whether to release the connection with a UE to the CN.

Example 3: A CN may perform a location verification. The CN may determine whether to re-trigger location verification. When the (total) number of times of location verification failure for a UE exceeds or is over a threshold, the CN may determine to release a connection with the UE or may indicate a reliability of the UE to the BS. The procedures/operation(s) associated with and/or following the connection release can be same as in example 1 and example 2.

In some embodiments, each trigger of location verification can be independent. The network may trigger a location verification when needed. In such a case, the CN may send an indication to perform the location verification another time (e.g., to repeat or re-perform the location verification) to the wireless communication node. In certain embodiments, the network may trigger N times of location verification initially. Before finishing/completing the N times of location verification, if the network has already obtained a reliable verification result, the CN may send an indication not to perform the location verification another time to the wireless communication node.

Example 4: A CN may indicate one or more criteria for a location verification to a BS. The BS may perform the location verification based on the criteria and/or measured/UE reported assistance information. The BS may determine whether to release a connection with the UE. The BS may indicate a reason for the connection release to the UE. The BS may report its decision on whether to release the connection with a UE to the CN. The BS may store a reliability of the UE and/or report a reliability of the UE to the CN.

Example 5: A CN may indicate one or more criteria for a location verification to a BS. The BS may perform a location verification based on the criteria and/or measured/UE reported assistance information. The BS may determine whether to re-trigger location verification. When the (total/aggregate number of) times of location verification failure for a UE is over a threshold, the BS may determine to release a connection with the UE. The procedures/operation(s) associated with and/or following the connection release can be same as in example 4.

Example 6: Criteria for a location verification can be pre-defined at a BS. The BS may perform a location verification based on the criteria and/or measured/UE reported assistance information. The other/follow-up procedures can be same as in example 4 and example 5.

In above examples, the assistance information used for the location verification may be obtained through a measurement and/or a UE reporting. The assistance information obtained from the measurement by a communication node (e.g., a core network (CN), a function entity of core network (CN), a radio access network (RAN), and/or a base station (BS)) may comprise at least one of: a round trip time (RTT), an uplink reference signal time difference of arrival (UL RS TDOA), an angle of arrival (AOA), or a reference signal received power (RSRP).

The assistance information obtained from the UE reporting may comprise at least one of: : a time gap between a receiving downlink reference signal and a transmitting uplink reference signal, a coherence level between different uplink reference signals, a tracking area (TA) value, a location of the wireless communication device (e.g., UE), a trajectory of the wireless communication device, a mobility status of the wireless communication device, a time instance corresponding to any of above, or a capability and/or type of the wireless communication device. The mobility status of the wireless communication device may include at least one of the following: a speed value, a moving direction, a velocity vector, or a speed range index. The capability and/or type of the wireless communication device may help the network obtain an uncertainty of estimated location.

The criteria for the location verification may comprise at least one of: a target value range, a target value, a tolerable range of error, or a confidence level, for at least one of: the assistance information measured by the wireless communication node, or the assistance information received from the wireless communication device. For example, the CN may indicate a tolerable error range and/or a target value of a location. If an error/difference between the UE reported location and the target location indicated from the CN is larger than the tolerable range, the BS may determine that the location verification has failed.

In above examples, the reliability may be a reliability flag. If the location verification has failed, the UE may be assigned with a flag indicating that the reliability of the UE is low. If the location verification has succeeded, the UE may be assigned with a flag indicating that the reliability of the UE is high. Multiple levels of reliability flags may be defined/assigned according to an estimated error/confidence level in verification and/or (the number of) times of location verification failure. When a UE accesses a network, a CN or a BS may check the reliability/flag of the UE. If the CN or the BS finds/determines that the UE is not reliable enough (e.g., the UE has been assigned with an unreliable flag or the specific flag level is below or equal to a threshold), the CN or the BS may reject the UE access (e.g., to the RAN). If CN or the BS finds/determines that the UE is reliable enough (e.g., the UE has been assigned with a reliable flag or has a flag level that is greater than or equal to a threshold), the CN or the BS may directly allow the UE access to the network. If the CN or the BS finds/determines that they are not sure of the UE reliability (e.g., the UE has not been verified before or has been assigned with a pending/intermediate flag, or the flag level is within a certain range), the CN or the BS may trigger a location verification of the UE. With this mechanism, a frequency and/or cost of location verification can be reduced.

The reliability/flag may be assigned by the CN or the BS. When assigning a reliability/flag to the UE, it may be associated with at least one of an international mobile equipment identity (IMEI), an international mobile subscriber identity (IMSI), a radio network temporary identity (RNTI), or other defined virtual identity (ID). In order to support this mechanism at the BS, the BS may obtain an IMEI/IMSI through an indication from the CN or a report from the UE. The reliability/flag may be valid for a period of time. The period/duration of valid time may be determined according to the estimated error/confidence level in verification or the number of times of location verification failure. The period of valid time may be infinitely long (e.g., when the reliability/flag is permanently valid).

To accommodate above examples of the location verification, the BS may support at least one of following signaling indication and/or functions.

The verification related indication from the CN may include at least one of: an indication to release a connection with a UE, a reason why the connection is released, a reliability/flag of a UE and/or the corresponding valid time period, or an indication to re-trigger location verification, for at least one of: the assistance information measured by the wireless communication node, or the assistance information received from the UE.

The criteria for the location verification may comprise at least one of: a target value range, a target value, a tolerable range of error, or a confidence level, for at least one of: the assistance information measured by the wireless communication node, or the assistance information received from the UE.

The assistance information measured by the wireless communication node (e.g., a BS) may comprise at least one of: a round trip time (RTT), a time difference of arrival (TDOA), a timing advance (TA), a reference signal received power (RSRP), or location. The time instance corresponding to above parameters may also be indicated. Multiple criteria may be associated with different UE type and/or capability.

In some embodiments, the wireless communication node (e.g., a BS) may verify the UE location based on assistance information and/or verification criteria. The wireless communication node may release a connection with a UE based on at least one of: a release indication from the CN, a reliability/flag and/or the corresponding valid time period indicated from the CN, a result of location verification performed at the BS, or a reliability/flag for the UE stored at the BS. The re-triggering of location verification can be based on (or initiated by) at least one of: a re-trigger indication from the CN, a reliability/flag and/or the corresponding valid time period indicated from the CN, a result of location verification performed at the BS, or a reliability/flag for the UE stored at the BS.

The wireless communication node (e.g., the BS) may assign a reliability/flag to a UE. The assigning of a reliability/flag may include at least one of: associating/assigning a reliability/flag with/to at least one of a IMEI, a IMSI, a RNTI, or other virtual ID; and/or setting a valid time of/for the reliability/flag.

In some embodiments, a “flag” can be regarded as a specific form/representation of “reliability”. For example, if “flag=1” means reliable and “flag=0” means unreliable, “flag=1” can be thought equal to “reliability=100%” and “flag=0” can be thought to be equal to “reliability-0%”. The association with a UE ID and a valid time may be represented by a “reliability” instead of a “flag.”

In order to support the mechanism at the BS, BS may obtain IMEI/IMSI through an indication from the CN or a report from the UE. The BS may indicate to the UE at least one of: a reason why the connection is released; or the UE is not allowed to access the network.

The report to the CN may include at least one of: an indication that the connection to a UE is released; a reason why the connection is released; or a reliability/flag for a UE and/or the corresponding valid time period.

It should be understood that one or more features from the above implementation examples are not exclusive to the specific implementation examples, but can be combined in any manner (e.g., in any priority and/or order, concurrently or otherwise).

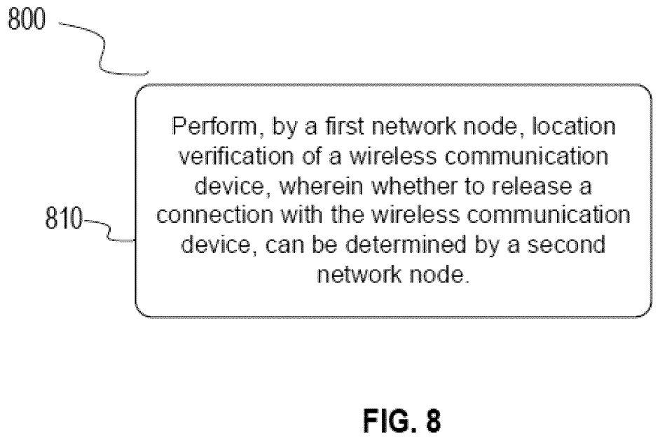

FIG. 8 illustrates a flow diagram of a method 800 for location verification of a user equipment (e.g., verifying a location of the UE). The method 800 may be implemented using any one or more of the components and devices detailed herein in conjunction with FIGS. 1-2. In overview, the method 800 may be performed by a first network node, in some embodiments. Additional, fewer, or different operations may be performed in the method 800 depending on the embodiment. At least one aspect of the operations is directed to a system, method, apparatus, or a computer-readable medium.

A first network node (e.g., a core network (CN), a radio access network (RAN), and/or a base station (BS)) may perform location verification of a wireless communication device (e.g., a user equipment (UE)). Whether to release a connection (e.g., of the BS or RAN) with the wireless communication device can be determined by a second network node.

In some embodiments, the first network node may comprise at least one node of a core network (CN). The second network node may comprise a wireless communication node of a radio access network (RAN). In some embodiments, the second network node may comprise the at least one node of the CN. The first network node may comprise the wireless communication node of the RAN. In some embodiments, the first network node and the second network node may be/comprise the at least one node of the CN. In some embodiments, the at least one node of the CN may comprise at least one of a function entity. In some embodiments, the first network node and the second network node may be/comprise the wireless communication node of the RAN. In some embodiments, the first network node and the second network node may be same. In some embodiments, the first network node and the second network node may comprise different function entities in the CN.

In some embodiments, the at least one node of the CN may initiate and/or perform the location verification. The at least one node of the CN may determine to release or not to release the (e.g., BS' or RAN's) connection with the wireless communication device according to the location verification. The at least one node of the CN may send an indication to release or not to release the connection with the wireless communication device to the wireless communication node. The at least one node of the CN may send information supporting the indication to release or not to release the connection to the wireless communication node. In some embodiments, the information supporting the indication to perform or not to perform the location verification another time comprises at least one of: a reason why to perform location verification another time, a reason why not to perform location verification another time, a notification that a wireless device has passed/failed a location verification, or a notification that normal transmission can be performed. The wireless communication node can be configured to release or not to release the connection according to at least one of: the indication, or the supporting information. To release the connection may comprise at least one of: to release a radio resource control (RRC) connection with the wireless communication device, or to reject access (e.g., to the RAN) from the wireless communication device.

In some embodiments, the at least one node of the CN may perform the location verification. The at least one node of the CN may send an indication of reliability of the wireless communication device, according to the location verification to wireless communication node. The wireless communication node can be configured to at least one of: determine to release or not to release the connection with the wireless communication device, according to the indication of reliability; or send a decision of the wireless communication node to release or not to release the connection, to the at least one node of the CN.

In some embodiments, the at least one node of the CN may perform the location verification. The at least one node of the CN may determine to perform or not to perform the location verification another time, according to the location verification. The at least one node of the CN may send a first indication to perform or not to perform the location verification another time to the wireless communication node. The at least one node of the CN may send a second indication to release or not to release the connection with the wireless communication device, when a number of times the location verification is performed exceeds a threshold, to the wireless communication node.

In some embodiments, the wireless communication node may perform the location verification according to at least one of: a criteria of the location verification, assistance information measured by the wireless communication node, or assistance information received from the wireless communication device. The wireless communication node may determine to release or not to release the connection with the wireless communication device according to the location verification. The wireless communication node may send/report at least one of: a decision of the wireless communication node to release or not to release the connection, or information supporting to release or not to release the connection, to the at least one node of the CN. In some embodiments, the information supporting the indication to perform or not to perform the location verification another time comprises at least one of: a reason why to perform location verification another time, a reason why not to perform location verification another time, a notification that a wireless device has passed/failed a location verification, or a notification that normal transmission can be performed. The wireless communication node may send an indication of a reliability of the wireless communication device to the at least one node of the CN. The wireless communication node may store/maintain the reliability of the wireless communication device.

In some embodiments, the wireless communication node may perform the location verification according to at least one of: a criteria of the location verification, assistance information measured by the wireless communication node, or assistance information received from the wireless communication device. The wireless communication node may determine to perform or not to perform the location verification another time according to the location verification. The wireless communication node may send at least one of: a decision of the wireless communication node to perform or not to perform the location verification another time, or information supporting to perform or not to perform the location verification another time, to the at least one node of the CN. In some embodiments, the information supporting the indication to perform or not to perform the location verification another time comprises at least one of: a reason why to perform location verification another time, a reason why not to perform location verification another time, a notification that a wireless device has passed/failed a location verification, or a notification that normal transmission can be performed. The wireless communication node may send a reliability of the wireless communication device to the at least one node of the CN. The wireless communication node may store the reliability of the wireless communication device. The wireless communication node may determine to release or not to release the connection with the wireless communication device, when a (total) number of times the location verification is performed (e.g., over a defined duration) exceeds a threshold.

In some embodiments, the criteria of the location verification can be pre-configured at the wireless communication node, or can be received from the at least one node of the CN. The assistance information measured by the wireless communication node may comprise at least one of: a round trip time, an uplink reference signal time difference of arrival, an angle of arrival, or a reference signal received power. The assistance information received from the wireless communication device may comprise at least one of: a time gap between a receiving downlink reference signal and a transmitting uplink reference signal, a coherence level between different uplink reference signals, a tracking area (TA) value, a location of the wireless communication device, a trajectory of the wireless communication device, a mobility status of the wireless communication device, a time instance corresponding to any of above, or a capability or type of the wireless communication device.

In some embodiments, the criteria for the location verification may comprise at least one of: a target value range, a target value, a tolerable range of error, or a confidence level, for at least one of: the assistance information measured by the wireless communication node, or the assistance information received from the wireless communication device. The wireless communication node may assign/associate/tag a flag to the wireless communication device according to the reliability. The wireless communication node may receive the flag for the wireless communication device from the at least one node of the CN. The wireless communication node may receive an identifier comprising at least one of: an international mobile equipment identity (IMEI), or an international mobile subscriber identity (IMSI), from the at least one node of the CN. The wireless communication node may associate the reliability or the flag with at least one of: the IMEI, the IMSI, a radio network temporary identity (RNTI), or a defined virtual identity (ID). The wireless communication node may set a valid time for the reliability or the flag (e.g., a time duration during which the reliability or the flag is/remains valid).

In some embodiments, the at least one node of the CN may assign a flag to the wireless communication device according to the reliability. The at least one node of the CN may receive the flag for the wireless communication device from the wireless communication node. The at least one node of the CN may associate the reliability or the flag with at least one of: an international mobile equipment identity (IMEI), an international mobile subscriber identity (IMSI), a radio network temporary identity (RNTI), or a defined virtual identity (ID). The at least one node of the CN may set a valid time for the reliability or the flag.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
performing, by a first network node, location verification of a wireless communication device,
wherein whether to release a connection with the wireless communication device, is determined by a second network node.

2. The method of claim 1, wherein:
the first network node comprises at least one node of a core network (CN), and the second network node comprises a wireless communication node of a radio access network (RAN); or
the second network node comprises the at least one node of the CN, and the first network node comprises the wireless communication node of the RAN; or
the first network node and the second network node comprise the at least one node of the CN; or
the first network node and the second network node comprise the wireless communication node of the RAN.

3. The method of claim 2, comprising at least one of:
performing, by the at least one node of the CN, the location verification;
determining, by the at least one node of the CN, to release or not to release the connection with the wireless communication device, according to the location verification;
sending, by the at least one node of the CN, to the wireless communication node, an indication to release or not to release the connection with the wireless communication device; or
sending, by the at least one node of the CN, to the wireless communication node, information supporting the indication to release or not to release the connection,
wherein the wireless communication node is configured to release or not to release the connection, according to at least one of: the indication, or the supporting information.

4. The method of claim 3, wherein to release the connection comprises at least one of:
to release a radio resource control (RRC) connection with the wireless communication device, or
to reject access from the wireless communication device.

5. The method of claim 2, comprising at least one of:
performing, by the at least one node of the CN, the location verification; or
sending, by the at least one node of the CN, to the wireless communication node, an indication of reliability of the wireless communication device, according to the location verification,
wherein the wireless communication node is configured to at least one of:
determine to release or not to release the connection with the wireless communication device, according to the indication of reliability; or
send a decision of the wireless communication node to release or not to release the connection, to the at least one node of the CN.

6. The method of claim 2, comprising at least one of:
performing, by the at least one node of the CN, the location verification;
determining, by the at least one node of the CN, to perform or not to perform the location verification another time, according to the location verification;
sending, by the at least one node of the CN, to the wireless communication node, a first indication to perform or not to perform the location verification another time; or
sending, by the at least one node of the CN, to the wireless communication node, a second indication to release or not to release the connection with the wireless communication device, when a number of times the location verification is performed exceeds a threshold.

7. The method of claim 2, comprising at least one of:
performing, by the wireless communication node, the location verification according to at least one of: a criteria of the location verification, assistance information measured by the wireless communication node, or assistance information received from the wireless communication device;
determining, by the wireless communication node according to the location verification, to release or not to release the connection with the wireless communication device;
sending, by the wireless communication node to the at least one node of the CN, at least one of: a decision of the wireless communication node to release or not to release the connection, or information supporting to release or not to release the connection;
sending, by the wireless communication node to the at least one node of the CN, a reliability of the wireless communication device; or
storing, by the wireless communication node, the reliability of the wireless communication device.

8. The method of claim 2, comprising at least one of:
performing, by the wireless communication node, the location verification according to at least one of: a criteria of the location verification, assistance information measured by the wireless communication node, or assistance information received from the wireless communication device;
determining, by the wireless communication node according to the location verification, to perform or not to perform the location verification another time;
sending, by the wireless communication node to the at least one node of the CN, at least one of: a decision of the wireless communication node to perform or not to perform the location verification another time, or information supporting to perform or not to perform the location verification another time;
sending, by the wireless communication node to the at least one node of the CN, a reliability of the wireless communication device;
storing, by the wireless communication node, the reliability of the wireless communication device; or
determining, by the wireless communication node, to release or not to release the connection with the wireless communication device, when a number of times the location verification is performed exceeds a threshold.

9. The method of claim 7, wherein the criteria of the location verification is pre-configured at the wireless communication node, or is received from the at least one node of the CN.

10. The method of claim 7, wherein the assistance information measured by the wireless communication node comprises at least one of:
a round trip time,
an uplink reference signal time difference of arrival,
an angle of arrival, or
a reference signal received power.

11. The method of claim 7, wherein the assistance information received from the wireless communication device comprises at least one of:
a time gap between a receiving downlink reference signal and a transmitting uplink reference signal,
a coherence level between different uplink reference signals,
a tracking area (TA) value,
a location of the wireless communication device,
a trajectory of the wireless communication device,
a mobility status of the wireless communication device,
a time instance corresponding to any of above, or
a capability or type of the wireless communication device.

12. The method of claim 10, wherein the criteria for the location verification comprises at least one of:
a target value range,
a target value,
a tolerable range of error, or
a confidence level,
for at least one of: the assistance information measured by the wireless communication node, or the assistance information received from the wireless communication device.

13. The method of claim 5, comprising at least one of:
assigning, by the wireless communication node, a flag to the wireless communication device according to the reliability;
receiving, by the wireless communication node from the at least one node of the CN, the flag for the wireless communication device;
receiving, by the wireless communication node from the at least one node of the CN, at least one of: an international mobile equipment identity (IMEI), or an international mobile subscriber identity (IMSI);
associating, by the wireless communication node, the reliability or the flag with at least one of: the IMEI, the IMSI, a radio network temporary identity (RNTI), or a defined virtual identity (ID); or
set, by the wireless communication node, a valid time for the reliability or the flag.

14. The method of claim 3, comprising at least one of:
assigning, by the at least one node of the CN, a flag to the wireless communication device according to the reliability;
receiving, by the at least one node of the CN from the wireless communication node, the flag for the wireless communication device;
associating, by the at least one node of the CN, the reliability or the flag with at least one of: an international mobile equipment identity (IMEI), an international mobile subscriber identity (IMSI), a radio network temporary identity (RNTI), or a defined virtual identity (ID); or
set, by the at least one node of the CN, a valid time for the reliability or the flag.

15. A first network node, comprising:
at least one processor configured to:
perform location verification of a wireless communication device,
wherein whether to release a connection with the wireless communication device, is determined by a second network node.

16. The first network node of claim 15, wherein:
the first network node comprises at least one node of a core network (CN), and the second network node comprises a wireless communication node of a radio access network (RAN); or
the second network node comprises the at least one node of the CN, and the first network node comprises the wireless communication node of the RAN; or
the first network node and the second network node comprise the at least one node of the CN; or
the first network node and the second network node comprise the wireless communication node of the RAN.

17. The first network node of claim 16, wherein the at least one processor is configured to at least one of:
perform, at the at least one node of the CN, the location verification;
determine, at the at least one node of the CN, to release or not to release the connection with the wireless communication device, according to the location verification;
send, at the at least one node of the CN, to the wireless communication node, an indication to release or not to release the connection with the wireless communication device; or
send, at the at least one node of the CN, to the wireless communication node, information supporting the indication to release or not to release the connection,
wherein the wireless communication node is configured to release or not to release the connection, according to at least one of: the indication, or the supporting information.

18. The first network node of claim 17, wherein to release the connection comprises at least one of:
to release a radio resource control (RRC) connection with the wireless communication device, or
to reject access from the wireless communication device.

19. The first network node of claim 16, wherein the at least one processor is configured to at least one of:
perform, at the at least one node of the CN, the location verification; or
send, at the at least one node of the CN, to the wireless communication node, an indication of reliability of the wireless communication device, according to the location verification,
wherein the wireless communication node is configured to at least one of:
determine to release or not to release the connection with the wireless communication device, according to the indication of reliability; or
send a decision of the wireless communication node to release or not to release the connection, to the at least one node of the CN.

20. The first network node of claim 16, wherein the at least one processor is configured to at least one of:
perform, at the at least one node of the CN, the location verification;
determine, at the at least one node of the CN, to perform or not to perform the location verification another time, according to the location verification;
send, at the at least one node of the CN, to the wireless communication node, a first indication to perform or not to perform the location verification another time; or
send, at the at least one node of the CN, to the wireless communication node, a second indication to release or not to release the connection with the wireless communication device, when a number of times the location verification is performed exceeds a threshold.
